(19) United States
(12) Patent Application Publication
(10) Pub. No.: US 2004/0064678 A1
(43) Pub. Date: Apr. 1, 2004

(54) Hierarchical scheduling windows

(76) Inventors: Bryan P. Black, Austin, TX (US); Edward A. Brekelbaum, Austin, TX (US); Jeff P. Rupley II, Round Rock, TX (US)

Correspondence Address: Lester J. Vincent, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/261,578

(22) Filed: Sep. 30, 2002

(51) Int. Cl. G06F 9/30

(52) U.S. Cl. 712/214

(57) ABSTRACT

A scheduling window hierarchy to facilitate high instruction level parallelism by issuing latency-critical instructions to a fast schedule window or windows where they are stored for scheduling by a fast scheduler or schedulers and execution by a fast execution unit or execution cluster. Furthermore, embodiments of the invention pertain to issuing latency-tolerant instructions to a separate scheduler or schedulers and execution unit or execution cluster.

### FIELD

Embodiments of the invention relate to the field of microprocessor architecture. More particularly, embodiments of the invention relate to a scheduling window hierarchy for scheduling instructions for execution within a microprocessor.

### BACKGROUND

The performance of a superscalar microprocessor is a function of, among other things, core clock frequency and the amount of instruction level parallelism (ILP) that can be derived from application software executed by the processor. ILP is the number of instructions that may be executed in parallel within a processor architecture. In order to achieve a high degree of ILP, microprocessors may use large scheduling windows, high scheduling bandwidth, and numerous execution units. Larger scheduling windows allow a processor to more easily reach around blocked instructions to find ILP in the code sequence. High instruction scheduling bandwidth can sustain instruction issue rates required to support a large window, and more execution units can enable the execution of more instructions in parallel.

FIG. 1 illustrates a prior art monolithic scheduling technique. Instructions are dispatched and stored in the monolithic scheduling window, scheduled, and executed.

Although larger scheduling windows are effective at deriving ILP from a software application, implementation of larger scheduling windows at high frequency presents at least three challenges. First, larger scheduling windows typically have slower select and wakeup logic. Second, additional execution units present extra load on bypass networks and delay between the execution units. Third, large scheduling windows can consume substantial power. Therefore, scaling current scheduler implementations in size, bandwidth, and frequency is becoming increasingly difficult.

### BRIEF DESCRIPTION OF THE DRAWINGS

Embodiments and the invention are illustrated by way of example and not limitation in the figures of the accompanying drawings, in which like references indicate similar elements and in which:

FIG. 1 illustrates a prior art scheduling window technique.

FIG. 2 illustrates a computer system in which one embodiment of the invention may be implemented.

FIG. 3 illustrates a microprocessor in which one embodiment of the invention may be implemented.

FIG. 4 illustrates a scheduling window hierarchy one embodiment of the invention.

FIG. 5 illustrates a mover according to one embodiment of the invention.

FIG. 6 illustrates a multiple scheduling window hierarchy according to one embodiment of the invention.

FIG. 7 illustrates a multiple-branch scheduling window hierarchy according to one embodiment of the invention.

FIG. 8 illustrates a multiple-branch, multiple-scheduling window hierarchy according to one embodiment of the invention.

FIG. 9 is a flow chart illustrating a method for performing one embodiment of the invention.

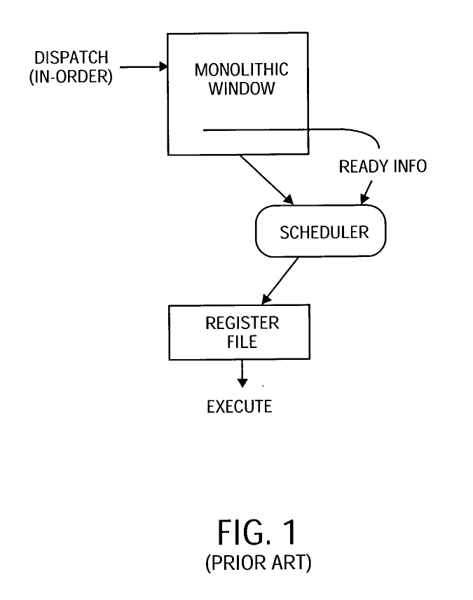

### DETAILED DESCRIPTION

Embodiments of the invention described herein help improve instruction scheduling performance within a computer system by using a scheduling window hierarchy that optimizes scheduling latency and scheduling window size. Moreover, embodiments of the invention use a scheduling mechanism that facilitates the implementation of a very large scheduling window at a high processor frequency.

Embodiments of the invention exploit instructions that are likely to be latency tolerant in order to reduce scheduling complexity. Furthermore, in order to improve scheduling window scaling without inducing undue system latency, two or more levels of scheduling windows may be used. The first level comprises one or more large, slow windows and subsequent levels comprise smaller, faster windows. The slow windows provide a large amount of scheduler capacity in order to extract a relatively large amount of instruction level parallelism (ILP) from a software application, while the fast windows are small enough to maintain high scheduling and execution bandwidth by maintaining low scheduling latency.

Furthermore, a selection heuristic may be implemented in at least one embodiment of the invention to identify latency-tolerant instructions. Latency-tolerant instructions may be issued for execution from slow windows, while latency critical instructions may be issued from fast windows. Each scheduling window may have a dedicated execution unit cluster or may share execution unit. The scheduling window hierarchy described herein provides, in effect, a scalable instruction window that tolerates wakeup, select, and bypass latency, while deriving (“extracting”) ILP from a software application.

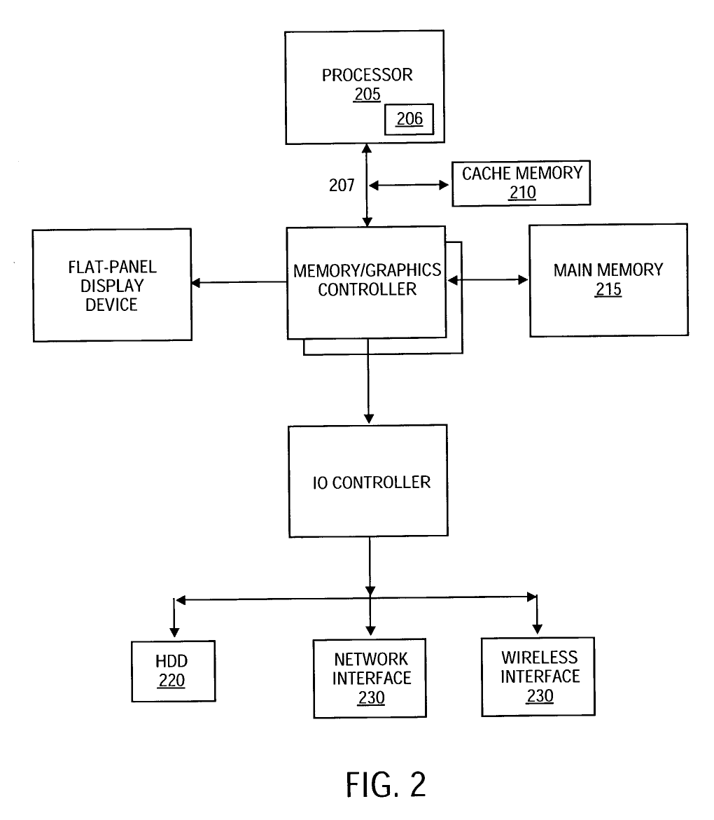

FIG. 2 illustrates a computer system that may be used in conjunction with one embodiment of the invention. A processor 205 accesses data from a cache memory 210 and main memory 215. Illustrated within the processor of FIG. 2 is one embodiment of the invention 206. However, embodiments of the invention may be implemented within other devices within the system, such as a separate bus agent, or distributed throughout the system in hardware, software, or some combination thereof. The main memory may be implemented in various memory sources, such as dynamic random-access memory (DRAM), a hard disk drive (HDD) 220, or a memory source located remotely from the computer system via network interface 230 containing various storage devices and technologies. The cache memory may be located either within the processor or in close proximity to the processor, such as on the processor's local bus 207. Furthermore, the cache memory may contain relatively fast memory cells, such as a six-transistor (6T) cell, or other memory cell of approximately equal or faster access speed.

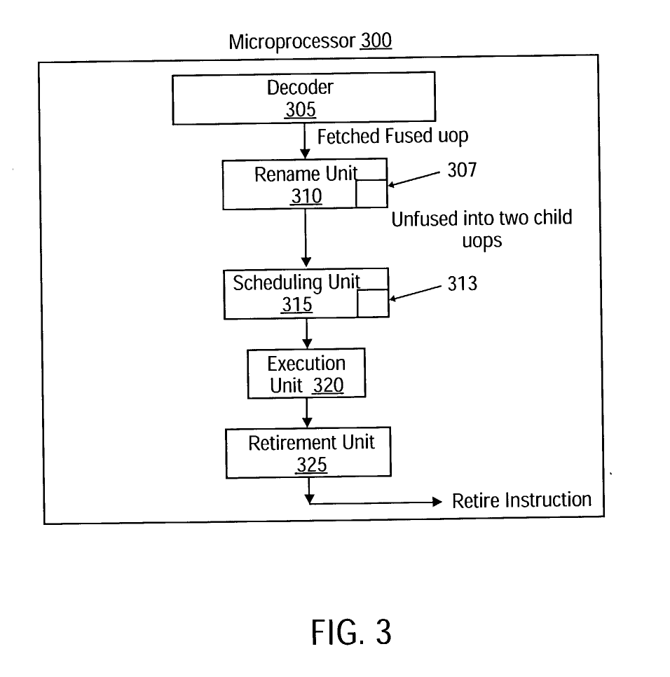

FIG. 3 illustrates a microprocessor architecture in which embodiments of the invention may be implemented. The processor 300 of FIG. 3 comprises an execution unit 320, a scheduling unit 315, rename unit 310, retirement unit 325, and decoder unit 305.

In one embodiment of the invention, the microprocessor is a pipelined, super-scalar processor that may contain multiple stages of processing functionality. Accordingly, multiple instructions may be processed concurrently within the processor, each at a different pipeline stage. Furthermore, the execution unit may be part of an execution cluster in order to process instructions of a similar type or similar attributes, such as latency-tolerance. In other embodiments, the execution unit may be a single execution unit.

The scheduling unit may contain various functional units, including embodiments of the invention 313. Other embodiments of the invention may reside elsewhere in the processor architecture of FIG. 3, including the rename unit 307. According to one embodiment of the invention, the scheduling unit comprises at least one scheduling window, one or more register files to provide instruction source data, and one or more schedulers to schedule instructions for execution by an execution unit.

A scheduling window may be logically and/or physically separated into two windows corresponding to latency requirements of the instructions stored therein. In one embodiment of the invention, the scheduling window contains two scheduling windows of different sizes to form a scheduling hierarchy based on a latency selection heuristic. In other embodiments, the scheduling window could be one scheduling window that is logically segmented to function as two separate windows.

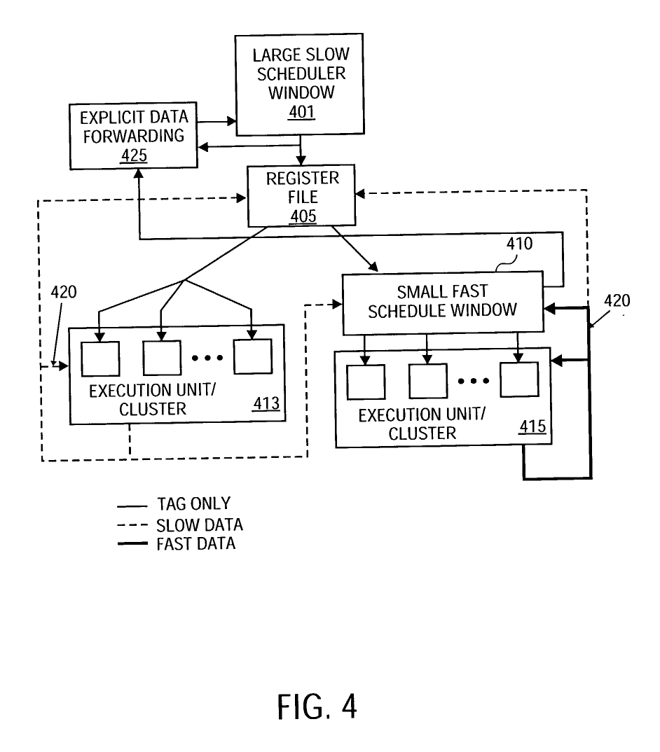

FIG. 4 illustrates a scheduling window hierarchy according to one embodiment of the invention. The scheduling window hierarchy of FIG. 4 comprises a slow scheduling window 401, a register file 405, a fast scheduling window 410, and execution clusters 413, 415 with a bypass network 420. Each scheduling window may have a dedicated and independent scheduler that schedules only instructions within its window. In some embodiments of the invention, there may be a scheduling window associated with each execution unit or cluster 413, 415, whereas in other embodiments, each scheduling window may be associated with a group of execution units or clusters.

Instructions are dispatched into the slow scheduling window. From the slow window latency-tolerant instructions are issued directly to execution cluster #0 413 and latency-critical instructions are moved to the fast window. Source operands are read from the register file. In the fast window, ready instructions are scheduled by a fast scheduler into cluster #1 415.

The scheduling window hierarchy exploits instructions that are likely to be latency-tolerant. Selection heuristics associated with the slow window identify instructions as either latency-tolerant or latency-critical (latency-intolerant). Latency-tolerant instructions are instructions whose execution can be delayed execution without impacting performance significantly, whereas latency-critical instructions require more immediate execution once they are scheduled.

The heuristic that determines whether instructions are moved from the slow to the fast window also ensures that instructions in the fast window are highly interdependent and latency critical. Scheduling interdependent latency-critical instructions in the fast window facilitates execution of back-to-back dependent instructions. Issuing only latency critical instructions to the fast window also simplifies the bypass network by dividing it into two regions; a small latency-critical network that bypasses data in cluster #1 and a latency-tolerant network that services cluster #0 and allows for communication between the two clusters.

Conversely, storing latency-tolerant instructions in the slow scheduling window facilitates the extraction of ILP. The slow window can be relatively large, because the latency-tolerant instructions stored within it can tolerate extra delay in wakeup, select, and bypass.

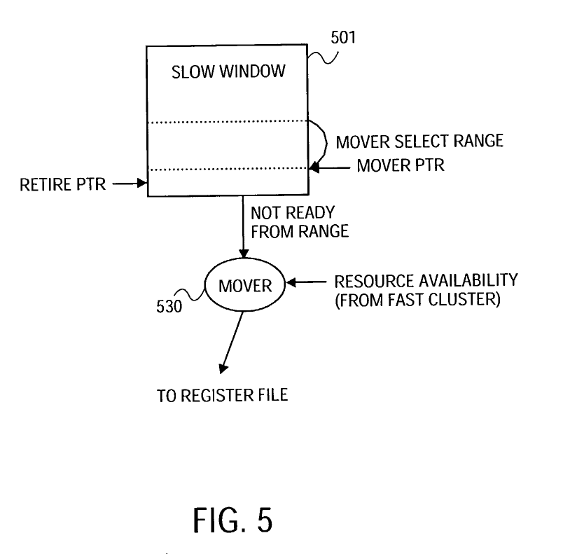

In at least one embodiment of the invention selection heuristic is implemented by a mover, illustrated in FIG. 5, which removes instructions from the slow window 501. The mover 530 may be implemented in a number ways. In one embodiment, the mover is a simple scheduler that selects the oldest latency-critical instructions from the slow window and copies them to the fast window, provided there is sufficient room available in the fast window. After the mover makes its selection, entries in the fast window are pre-allocated and the instructions are sent to the register file for operand read.

The selection heuristic is used to identify latency-critical instructions, which require fast scheduling and execution. For example, the selection heuristic can identify which instructions have remained in the large scheduler window for a certain amount of time, or within a certain time range, and distribute instructions to the scheduler accordingly. Because the slow scheduler selects instructions independently of the mover, it can create fragmentation in the mover's selection window, where latency-tolerant instructions have been issued to cluster #0. Consequently, the oldest latency-critical instructions may not reside in contiguous locations, but instead may be dispersed in the slow window.

Furthermore, because the slow window can be very large it may not be possible for the mover to search the entire space each cycle. To simplify the search, the mover maintains a head pointer into the slow window, from which to search for a number of latency-critical instructions. In the embodiment illustrated in FIG. 5 there is an eight-instruction window in which the mover searches. Larger or smaller instruction windows may be used, however. To facilitate forward progress and improve the effectiveness of the mover's small search window, instructions are allocated and de-allocated in-order from the slow window.

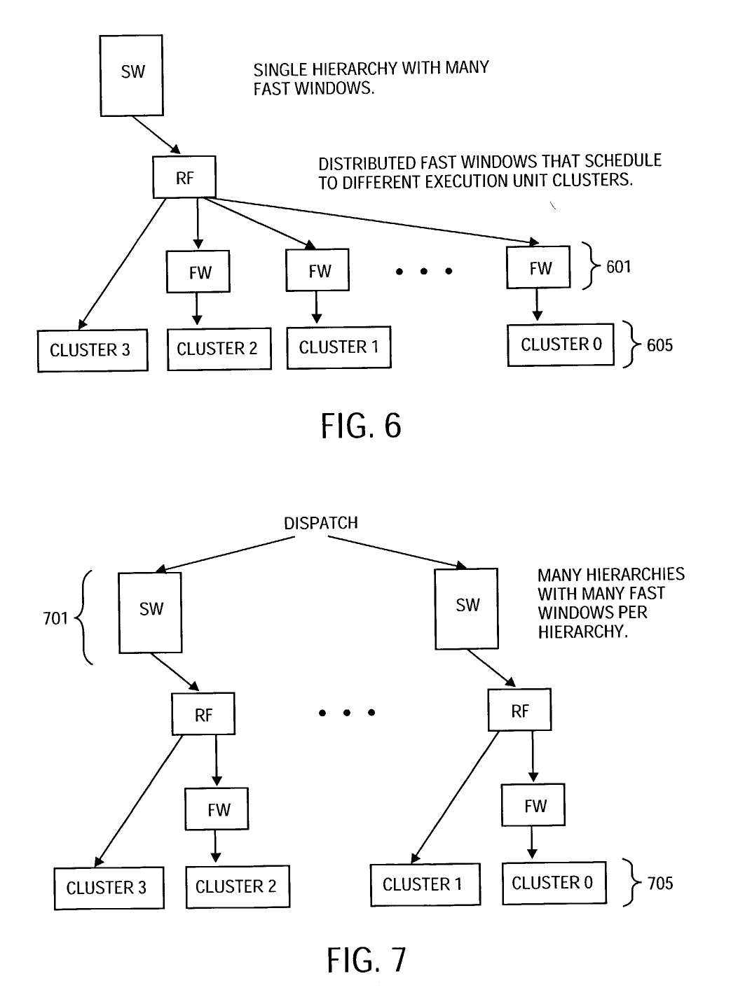

FIG. 6 illustrates another embodiment of the invention. The embodiment of the invention illustrated in FIG. 6 comprises distributed fast windows 601, each corresponding to a different execution cluster 605. The distributed fast windows allow latency-intolerant instructions to be scheduled and executed according to their latency characteristics, for example latency tolerance, rather than allowing scheduling all of the latency-intolerant instructions to be executed by one execution cluster.

FIG. 7 illustrates one embodiment of the invention. The embodiment of the invention illustrated in FIG. 7 comprises distributed slow windows 701, each corresponding to a different execution cluster 705. The distributed slow windows allow latency-tolerant instructions to be scheduled and executed according to their latency characteristics rather than scheduling all of the latency-tolerant instructions to be executed by one execution cluster.

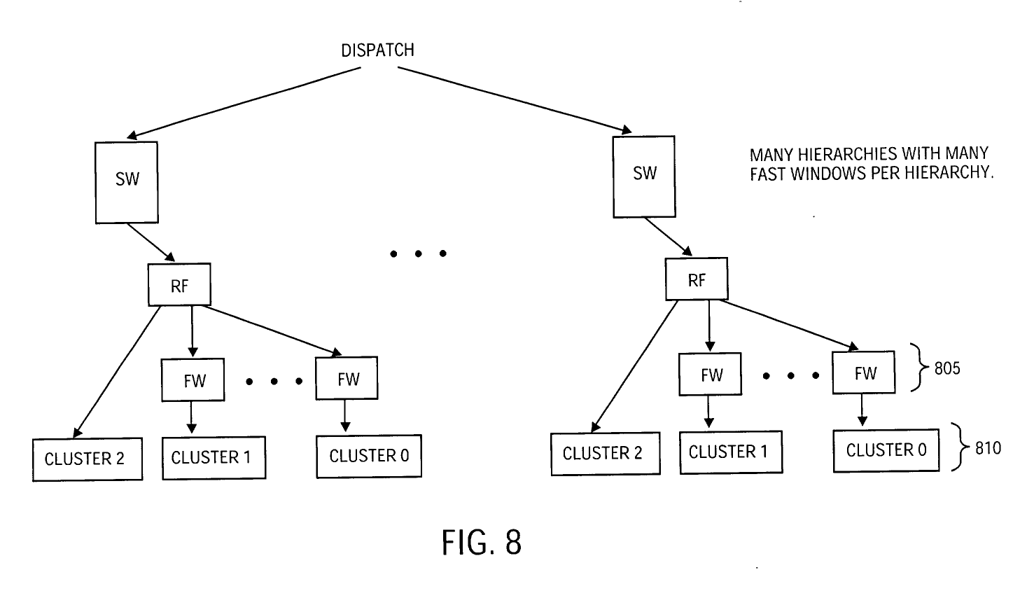

FIG. 8 illustrates one embodiment of the invention. The embodiment of the invention illustrated in FIG. 8 comprises distributed slow 801 and fast 805 windows, each corresponding to a different execution cluster 810. The distributed slow and fast windows allow latency-tolerant and latency-intolerant, respectively, instructions to be scheduled and executed according to their latency characteristics rather than scheduling all of the latency-tolerant and latency-intolerant instructions for execution by one slow execution cluster and by one fast execution cluster, respectively.

Alternative embodiments of the invention may contain multiple layers of windows, including multiple layers of large scheduling windows into which instructions are stored based upon their relative latency requirements. Similarly, embodiments of the invention may use multiple layers of small scheduling windows into which instructions are stored based upon their relative latency requirements, or a combination of multiple layers of large scheduling windows and multiple small windows, depending upon the implementation.

Furthermore, the scheduling windows may be combined with other logic or functional units within the microprocessor, including a reorder buffer for maintaining instruction order for the write-back and committing to processor state as instructions are executed. For an embodiment wherein the reorder buffer is implemented within the larger scheduling window, instructions scheduled in the larger window reside in a scheduled state and the reorder process is performed within the larger window rather than a separate reorder buffer.

The register file is used to pass source data to instructions. Accordingly, the register file location may effect scheduling window capacity, size, and/or performance. In one embodiment of the invention the register file is located between a large scheduling window layer of the hierarchy and a smaller scheduling window layer of the hierarchy. In such an embodiment, the source data used by the registers need not be stored in the large scheduling window(s) along with the instruction and instead may be passed to the instruction after it is removed from the large scheduling window for scheduling or execution.

According to other embodiments, however, the register file may be located before a large scheduling window(s) in the hierarchy such that the source data is assigned and stored with the instruction in the large scheduling window(s). Furthermore, other-embodiments may locate register files both above the large scheduling window(s), after the large scheduling window(s), and/or before and/or after the smaller scheduling window(s), depending on the needs of the system in which the embodiment is implemented.

Embodiments of the invention may be implemented using complimentary metal-oxide-semiconductor (CMOS) circuits (hardware). Furthermore, embodiments of the invention may be implemented by executing machine-readable instructions stored on a machine-readable medium (software). Alternatively, embodiments of the invention may be implemented using a combination of hardware and software.

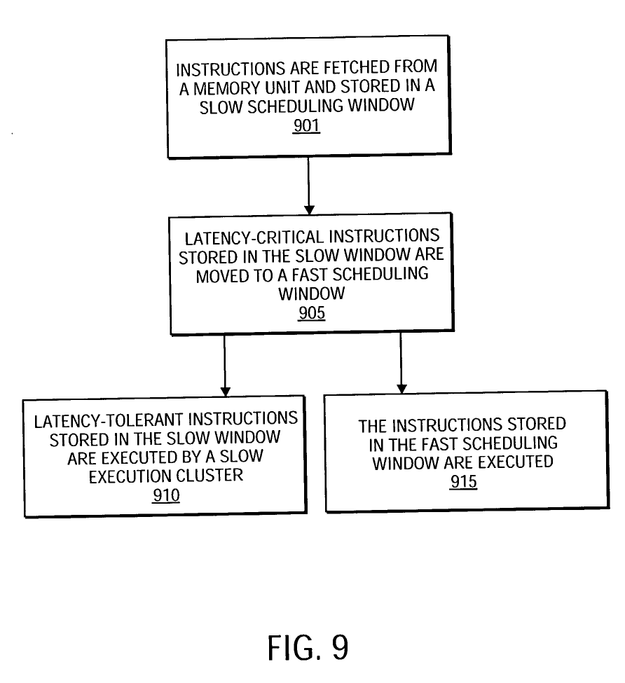

FIG. 9 is a flow diagram illustrating a method for scheduling instructions according to one embodiment of the invention. Instructions are fetched from a memory unit and stored in a slow scheduling window at operation 901. Latency-critical instruction stored in the slow window are moved to a fast scheduling window at operation 905. The latency-tolerant instructions stored in the slow window are executed by a slow execution cluster at operation 910 and the instructions stored in the fast scheduling window are executed at operation 915.

While the invention has been described with reference to illustrative embodiments, this description is not intended to be construed in a limiting sense. Various modification of the illustrative embodiments, as well as other embodiments, which are apparent to persons skilled in the art to which the invention pertains are deemed to lie within the spirit and scope of the invention.

What is claimed is:

1. An apparatus comprising:
a first schedule window;
a second schedule window coupled to the first schedule window, the first schedule window being larger than the second schedule window; and
a first unit to schedule a first instruction stored in the first schedule window without the first instruction being stored in the second schedule window before being scheduled.

2. The apparatus of claim 1 comprising a second unit to schedule a second instruction stored in the second schedule window that is able to schedule instructions faster than the first unit to schedule.

3. The apparatus of claim 1 further comprising:
a first execution cluster coupled to the first schedule window; and
a second execution cluster coupled to the second schedule window.

4. The apparatus of claim 3 wherein said first execution cluster comprises execution units to execute latency-tolerant instructions and the second execution cluster comprises execution units to execute latency-critical instructions.

5. The apparatus of claim 4 further comprising a register file coupled to the first and second scheduling windows, the register file comprising source data to be read by the latency-tolerant and latency-critical instructions.

6. The apparatus of claim 2 comprising a bypass path to provide source operands corresponding to instructions stored in the second scheduling window without reading the source operands from the register file.

7. The apparatus of claim 1 further comprising a plurality of first schedule windows and a plurality of second schedule windows coupled in a hierarchical topology so as to facilitate scheduling of instructions of different schedule latency tolerance.

8. A system comprising:
a memory unit, the memory unit comprising a latency-tolerant instruction and a latency-intolerant instruction;
a processor to fetch the latency-tolerant instruction from the memory unit before fetching the latency-intolerant instruction and to output a result of executing the latency-intolerant instruction before a result of executing the latency-tolerant instruction.

9. The system of claim 8 wherein the processor schedules the latency-tolerant and latency-intolerant instructions for execution in an order that is based upon a relative latency tolerance heuristic of the latency-intolerant and latency-tolerant instructions.

10. The system of claim 9 wherein the processor comprises a first scheduling window to store the latency-tolerant instruction and the latency-intolerant instruction.

11. The system of claim 10 wherein the processor comprises a second scheduling window to store the latency-intolerant instruction, the second scheduling window being smaller than the first scheduling window.

12. The system of claim 11 wherein the processor comprises a first execution cluster to execute the latency-tolerant instruction and a second execution cluster to execute the latency-intolerant instruction.

13. The system of claim 12 wherein the first scheduling window and the second scheduling window form a scheduling window hierarchy to optimize instruction scheduling latency and scheduling window size.

14. The system of claim 8 wherein the relative latency tolerance heuristic determines whether execution of an instruction can be delayed without effecting performance of the system.

15. The system of claim 13 wherein the relative latency tolerance heuristic is determined by an amount of time an instruction has remained stored in the first scheduling window.

16. The system of claim 15 wherein the processor comprises an execution unit to receive the latency-tolerant instruction from the first scheduling window without the latency-tolerant instruction first being stored in the second scheduling window.

17. A method comprising:
fetching a first instruction and a second instruction from a memory;
determining the scheduling latency-tolerance of the first and second instructions;
executing the first instruction before the second instruction if the first instruction is less tolerant of scheduling latency than the second instruction; and
executing the second instruction before the first instruction if it is less tolerant of scheduling latency than the first instruction.

18. The method of claim 17 further comprising storing the first and second instruction in a larger of two scheduling windows.

19. The method of claim 18 further comprising moving at least one of the first and second instructions to a smaller of the two scheduling windows if the at least one of the first and second instructions is intolerant of scheduling latency.

20. The method of claim 19 further comprising scheduling instructions stored in the larger of the two scheduling windows with a first scheduler; and
scheduling instructions stored in the smaller of the two scheduling windows with a second scheduler, the second scheduler being a faster scheduler than the first scheduler.

21. The method of claim 20 further comprising executing instructions scheduled by the first scheduler with a first execution unit; and
executing instructions scheduled by the second scheduler with a second execution unit, the second execution unit being faster than the first execution unit.

22. The method of claim 21 wherein the first instruction is latency-tolerant and the second instruction is latency-intolerant.

23. The method of claim 22 wherein the first instruction receives source data from a register file.

24. The method of claim 23 wherein the second instruction receives source data from a data bypass mechanism that provides source data to the second instruction before the data is stored in the register file.

25. A machine-readable medium having stored thereon a set of instructions, which when executed by a machine cause the machine to perform a method comprising:
fetching a plurality of instructions;
organizing the plurality of instructions according to scheduling latency tolerance of each of the plurality of instructions, the organizing comprising storing latency-tolerant instructions in a first scheduling window and storing latency-intolerant instructions in at least a second scheduling window, the first scheduling window being larger than the at least second scheduling window;
scheduling the plurality of instructions for execution according to scheduling latency tolerance of the plurality of instructions, the latency-tolerant instructions being scheduled at a slower rate than the latency-intolerant instructions; and
executing the plurality of instructions according to schedule latency tolerance of the plurality of instructions, the latency-tolerant instructions being executed at a slower rate than the latency-intolerant instructions.

26. The machine-readable medium of claim 25 wherein the latency-tolerant instructions are scheduled without being first stored in the at least second scheduling window.

27. The machine-readable medium of claim 25 wherein the latency-tolerant instructions are stored in a first plurality of scheduling windows and the latency-intolerant instructions are stored in a second plurality of scheduling windows, the first plurality of scheduling windows being larger than the second plurality of scheduling windows.

28. The machine readable medium of claim 25 wherein the plurality of instructions are executed by a plurality of execution clusters according to a plurality of execution speed of each of the plurality of execution clusters.

29. An apparatus comprising:
a first means for grouping a plurality of latency-tolerant instructions together;
a second means for grouping a plurality of latency-intolerant instructions together, the latency-intolerant instructions being fewer in number than the latency-tolerant instructions;
a first means for scheduling the plurality of latency-tolerant instructions without the plurality of latency-tolerant instructions being first grouped by said second means for grouping;
a second means for scheduling the plurality of latency-intolerant instructions, the first means for scheduling the plurality of latency-tolerant instructions being a slower means than the second means for scheduling the plurality of latency-tolerant instructions;
a first means for providing source data to the latency-tolerant instructions;
a second means for providing source data to the latency-intolerant instructions;
a first means for executing the latency-tolerant instructions; and
a second means for executing the latency-intolerant instructions, the second means for executing the latency-intolerant instructions being a faster means than the first means for executing the latency-tolerant instructions.

30. The apparatus of claim 29 wherein the first means for grouping and the second means for grouping are hierarchical scheduling windows.
